(19) United States
(12) Patent Application Publication
(10) Pub. No.: US 2026/0159156 A1
(43) Pub. Date: Jun. 11, 2026

(54) IMPROVED ASSEMBLY STRUCTURE FOR A STEERING YOKE OF A HYDRAULIC MACHINE

(71) Applicant: POCLAIN HYDRAULICS INDUSTRIE, Verberie (FR)

(72) Inventors: Clément Philippe Recoura, Verberie (FR); Laurent Naceur, Verberie (FR)

(73) Assignee: POCLAIN HYDRAULICS INDUSTRIE, Verberie (FR)

(21) Appl. No.: 19/125,997

(22) PCT Filed: Oct. 26, 2023
(86) PCT No.: PCT/FR2023/051689

§ 371 Date: Apr. 30, 2025

(30) Foreign Application Priority Data
Nov. 4, 2022 (FR) FR2211501

(51) Int. Cl. B62D 5/14

(52) U.S. Cl. CPC B62D 5/14

(57) ABSTRACT

An assembly has a hydraulic machine and a steering yoke, the hydraulic machine has a rotor and a stator movable in rotation relative to each other along an axis of rotation extending along an axial direction, the hydraulic machine includes a casing, the casing defining a pivot axis distinct from the axis of rotation, the steering yoke being assembled on the casing, via a plurality of assembly elements extending along the axial direction.

### TECHNICAL FIELD

The present invention relates to hydraulic machines coupled to steering members, and has an improved structure of such an assembly.

### PRIOR ART

Hydraulic machines are commonly used for various applications, for example to drive in rotation the travel members for vehicles or crafts, in particular steering members.

In the case where the hydraulic machine drives a steering member, it is then necessary to couple the hydraulic machine to steering means in a reliable and robust manner, without compromising the integration and the assembly of the system.

The present invention thus aims to at least partially address these problems.

### DISCLOSURE OF THE INVENTION

Assembly comprising a hydraulic machine and a steering yoke,
the hydraulic machine comprising a rotor and a stator movable in rotation relative to each other along an axis of rotation extending along an axial direction,
the hydraulic machine comprising a casing, the casing defining a pivot axis distinct from the axis of rotation,
the steering yoke being assembled on the casing,
characterized in that said steering yoke is assembled on the casing via a plurality of assembly elements extending along the axial direction, parallel to the axis of rotation.

According to one example, the steering yoke comprises a control portion defining a steering axis parallel to the pivot axis.

According to one example, said assembly elements comprise a plurality of elements adapted to be screwed into the casing, the assembly comprising at least one centering element each having a first end inserted into a housing formed in the casing, and a second end inserted into a housing formed in the steering yoke.

According to one example, the centering elements are mounted stressed in the casing 100 and in the steering yoke.

According to one example, the centering elements have an outer section strictly greater than a section of the housing formed in the casing and strictly greater than a section of the housing formed in the steering yoke.

According to one example, the assembly comprising two centering elements each having a first end inserted into a housing formed in the casing, and a second end inserted into a housing formed in the steering yoke.

According to one example, the hydraulic machine comprises a cam secured to the casing, the cam being secured to the casing by means of a plurality of fixing elements extending along the axial direction, the steering yoke comprising at least one bore along the axial direction aligned with at least one of said fixing elements, said bore having a section smaller than the maximum section of said fixing elements, in which the centering elements are positioned in the extension of the fixing elements.

According to one example, said centering elements have an annular shape with a central recess, each of said at least one bore of the steering yoke being aligned with the central recess of a centering element.

According to one example, each of said at least one bore of the steering yoke has a section strictly smaller than the section of the centering elements.

According to one example, the casing has two assembly areas adapted to receive a steering yoke, the steering yoke comprising a mistake-proofing adapted to allow the assembly of the steering yoke on a single assembly area of the casing.

The present invention also relates to a method for assembling such an assembly, in which the steering yoke is positioned on the casing, and the steering yoke is assembled on the casing via a plurality of assembly elements extending along the axial direction of the hydraulic machine.

According to one example, prior to positioning the steering yoke on the casing, centering elements are inserted under stress into housings formed in one among the steering yoke and the casing, then the steering yoke is positioned on the casing by inserting under stress the centering elements into housings formed in the other among the steering yoke and the casing.

The present disclosure also relates to a method for dismounting an assembly as presented, in which the assembly elements are removed, then a tool is introduced into the assembly bores so as to unscrew the fixing elements of the casing until the centering elements are extracted from the housings formed in the casing.

Following said dismounting operation, the fixing elements are then typically tightened to a nominal tightening value, so as to ensure the assembly of the hydraulic machine.

### BRIEF DESCRIPTION OF THE DRAWINGS

The invention and its advantages will be better understood upon reading the detailed description given below of different embodiments of the invention given as non-limiting examples.

FIG. 1 shows a perspective view of an assembly according to one aspect of the invention.

FIG. 2 shows a sectional view detailing how the assembly is assembled.

FIG. 3 shows another view detailing how the assembly is assembled.

Throughout the figures, the elements in common are identified by identical reference numerals.

### DESCRIPTION OF THE EMBODIMENTS

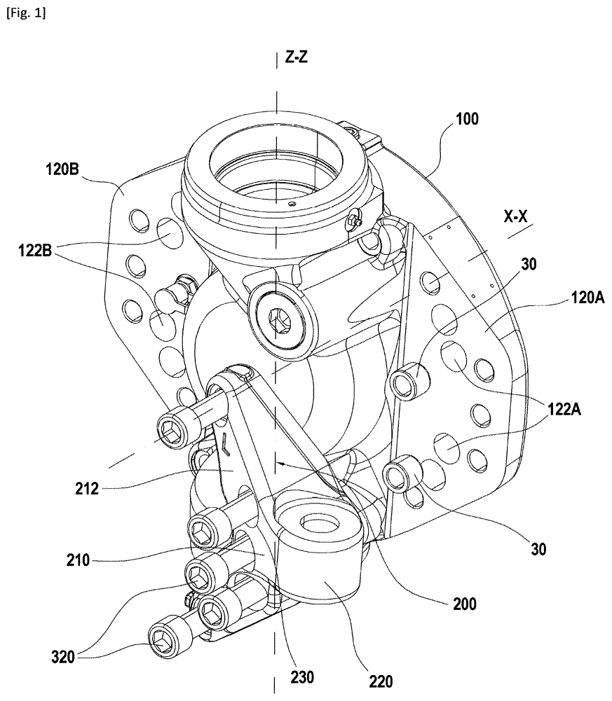

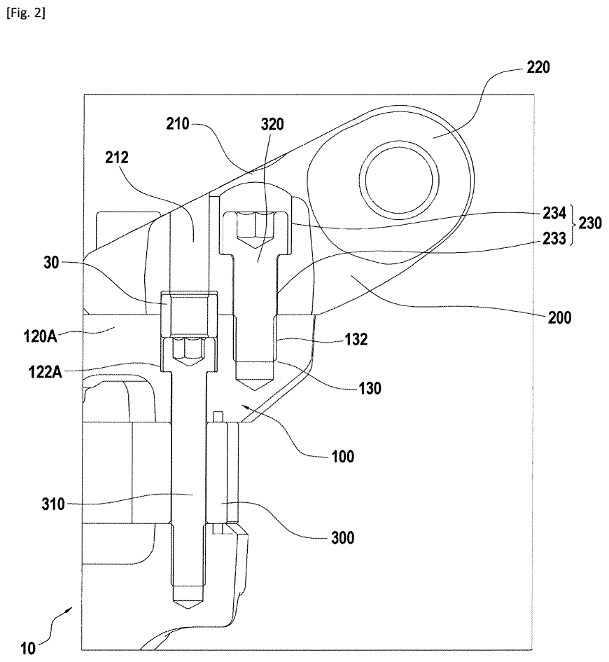

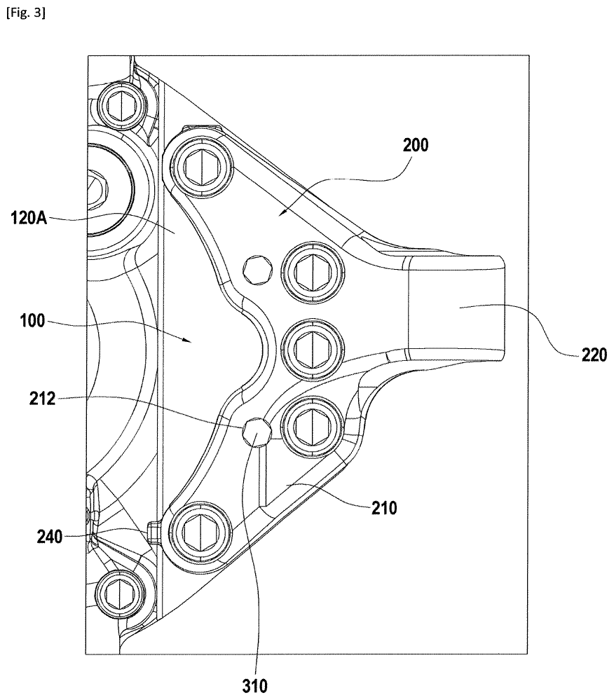

FIG. 1 represents a perspective view of a portion of a hydraulic machine casing associated with a steering yoke. FIGS. 2 and 3 are views illustrating the assembly of the steering yoke on the casing.

The casing 100 is a hydraulic machine casing 10 adapted to drive in rotation a member such as a steered wheel of a vehicle or a craft.

The casing 100 thus typically forms a first static assembly of a hydraulic machine relative to a second assembly movable in rotation and comprising in particular a shaft and a cylinder block according to the well-known structure of a hydraulic machine.

More generally, two axes are defined:
an axis of rotation X-X, corresponding to the relative axis of rotation of the shaft of the hydraulic machine relative to the casing 100, and
a pivot axis Z-Z, allowing the orientation of the hydraulic machine and therefore the associated member, for example a steered wheel.

A fixing frame is typically coupled to the elements defining the pivot axis Z-Z, so as to make a mounting movable in rotation along this pivot axis Z-Z. In a known manner, a rotating supply is typically formed in this pivot.

The axis of rotation X-X and the pivot axis Z-Z are distinct, and may for example be perpendicular or inclined at an angle comprised between 70° and 90° relative to each other. The axis of rotation X-X defines the axial direction of the hydraulic machine 10.

In order to control the orientation of the casing 100, and therefore of the hydraulic machine, the casing 100 is associated with a steering yoke 200. The steering yoke 200 is adapted to allow coupling an actuator to the casing 100 so as to control its rotation about the pivot axis Z-Z.

In the illustrated example, the steering yoke 200 has a structure comprising a pedestal 210 adapted to be fixed on the casing 100, and a control portion 220 adapted to be associated with an actuator.

In the example illustrated, the control portion 220 has the shape of a cylinder of revolution with a central through-channel allowing for example associating a rod therewith to define a control axis parallel to the pivot axis Z-Z.

The pedestal 210 is adapted to be fixed on the casing 100. The casing 100 thus has assembly areas, which are portions adapted to receive the pedestal 210 of the steering yoke 200. In the illustrated example, the casing 100 has two portions forming two lugs 120A and 120B on either side of the pivot axis Z-Z.

The two lugs are typically symmetrical relative to the pivot axis Z-Z. The structure of one of these lugs is described below, the other lug therefore typically having an identical or similar structure. The lugs will therefore be referred to by the general designation 120, the different elements of each lug being identified, where appropriate, with the index A or B depending on the considered lug 120A or 120B.

Each lug 120 typically forms a planar base adapted to receive the pedestal 210 of the steering yoke 200.

Each lug 120 also has a plurality of bores which are described below.

Each lug has cam bores 122, these cam bores 122 being adapted to allow the insertion of fixing elements 310 for example such as screws or bolts to assemble the casing 100 to a cam 300, typically a multi-lobe cam in the case of a radial-piston hydraulic machine.

The fixing elements 310 typically have a rod and a head, the head being housed in the cam bores 122 so as not to protrude from the planar surface defined by the considered lug 120, and therefore to be entirely housed in the cam bores 122.

The cam bores 122 are typically dimensioned so as to allow inserting a centering element 30 into each cam bore 122, which then overcomes the head of the considered fixing element 310. The centering element 30 is typically a hollow tubular element, having an external diameter substantially equal to the internal diameter of the cam bore 122 so as to be able to be inserted into said cam bore 122. The centering element 30 is for example a sleeve; it typically has a central through-recess dimensioned to allow inserting a tool through the centering element 30 in order to engage or disengage the fixing element 310.

The pedestal 210 then typically has centering bores 212, adapted to receive the centering elements 30. The centering bores 212 typically have a dimension greater than or equal to the dimension of the centering elements 30, and are dimensioned such that the centering elements 30 are fully housed in the centering bores 212 and the cam bores 122 when the steering yoke 200 is assembled on the casing 100. In the example illustrated, two centering elements 30 are used.

The centering elements 30 are typically tightly mounted in the steering yoke 200 and in the casing 100, that is to say there is an interference between the external diameter of the centering elements 30 and their housing formed in the steering yoke 200 and in the casing 100. The centering elements 30 then contract by elastic deformation. In this way, isostatic positioning without clearance of the steering yoke 200 on the casing 100 is guaranteed. The centering elements 30 also make it possible to transmit forces parallel to the bearing plane between the steering yoke 200 and the casing 100 during the use of the hydraulic machine that is to say for sliding forces between the steering yoke 200 and the casing 100.

Such a structure thus makes it possible to center and temporarily hold in position the steering yoke 200 on the casing 100. The centering bores 212 as proposed are typically through-bores. Thus, the head of the fixing elements 310 can be accessed when the steering yoke 200 is assembled on the casing 100.

The centering bores 212 of the pedestal 210 typically have two distinct sections; a first section adapted to receive the centering element 30, and a second section strictly smaller than the first section to allow the passage of a tool. The second section typically has a section equal or substantially equal to the section of the central through-recess of the centering element 30. The through-section of the second section of the centering bore 212 as well as the section of the central through-recess of the centering element 30 typically correspond to the section required for the passage of an imprint allowing turning the head of the fixing element 310 with a tool, for example a hollow hexagonal imprint.

Such a structure makes it possible in particular to use the fixing elements 310 in order to separate the steering yoke 200 from the casing 100. It is then possible to insert a tool via the centering bores 212 in order to unscrew the fixing elements 310, which will then push the steering yoke 200 due to the second section of the centering bores 212 of smaller diameter against which the fixing elements 310 and the centering elements 30 then come into abutment. Such functionality is particularly interesting when the centering elements 30 are press-fitted into the housings thus formed in the casing 100 and in the steering yoke 200.

After the use of the fixing elements 310 to extract the steering yoke 200 or the centering elements 30, if the machine must be kept assembled, the fixing elements 310 are typically tightened to the prescribed torque, since these fixing elements 310 participate in the assembly of the structure of the hydraulic machine.

The pedestal 210 has a plurality of assembly through-bores 230 for the passage of assembly elements 320 for example, such as screws or bolts. The lugs 120 of the casing 100 have assembly bores 130 disposed in a configuration identical to the assembly bores 230 of the pedestal 210, such that when the steering yoke 200 is positioned bearing against the casing 100 in an assembly position, the assembly bores 230 of the pedestal 210 and the assembly bores 130 of the casing 100 are aligned.

The assembly position typically corresponds to a position in which the centering elements 30 are interposed between the steering yoke 200 and the casing 100 and thus perform a centering function as described above. More specifically, the assembly position corresponds to the configuration in which each centering element 30 is partially inserted both into the steering yoke 200 and into the casing 100 and thus performs a function of centering and holding in position the steering yoke 200 relative to the casing 100 prior to the assembly by means of assembly elements. Furthermore, depending on its structure, the centering element 30 can also perform a function of reinforcing the connection between the casing 100 and the steering yoke 200, in particular by preventing shear forces from being applied to the fixing elements 310.

The assembly bores 230 of the pedestal 210 and the assembly bores 130 of the casing 100 thus allow the passage of assembly elements 320 to assemble the steering yoke 200 on the casing 100.

The assembly bores 130 of the casing 100 thus typically have a tapping 132 with which a thread of the associated assembly element 320 will cooperate.

The assembly bores 230 of the pedestal 210 typically have two portions with distinct sections; a rod section 232 and a head section 234 with a section strictly greater than the rod section, the change of section forming a shoulder in the assembly bores 230 of the pedestal 210. The assembly elements 320 typically have a rod and a head, the head having a section strictly greater than the rod.

Thus, when an assembly element 320 is inserted into the assembly bores 230 of the pedestal 210 and the assembly bores 130 of the casing 100, the head of the assembly element 320 bears against the shoulder formed in the assembly bores 230 of the pedestal 210, which ensures holding the steering yoke 200 on the casing 100.

The assembly as presented thus comprises two types of bores; the centering bores and the assembly bores, which perform respectively a centering and a temporary holding in position of the steering yoke on the casing, then its assembly.

In the assembly as proposed, the various bores are formed so as to be parallel to the axis of rotation X-X.

The various centering bores and the assembly bores as proposed all open out onto the same face of the considered lug 120 of the casing 100. Thus, the assembly means 320 and the fixing elements 310 are all inserted from the same side of the casing 100.

Such a structure thus makes it possible to simplify the assembly of the steering yoke 100 on the casing 200 insofar as the assembly is made along the same axial direction, unlike known structures in which assemblies along multiple directions are necessary.

Depending on the desired structure, the steering yoke 200 may be a single model that can be mounted on either of the lugs 120A and 120B, or have a specific shape to be mounted only on one of the lugs 120A and 120B. In such a case, the steering yoke 200 may comprise a mistake-proofing, adapted to allow the assembly of the steering yoke 200 only on either of the lugs 120A and 120B. In the illustrated example, the steering yoke 200 comprises a pin 240 forming a mistake-proofing, and adapted to come into abutment against an element of the casing 100 when the steering yoke is mounted on the wrong lug 120, such that the different orifices of the steering yoke 200 and of the casing 100 cannot then be aligned, which prevents the mounting of the steering yoke 200 and on the casing 100.

The invention as proposed thus makes it possible to optimize and simplify the assembly of the steering yoke 200 on the casing 100.

Although the present invention has been described with reference to specific exemplary embodiments, it is obvious that modifications and changes may be made to these examples without departing from the general scope of the invention as defined by the claims. Particularly, individual characteristics of the various illustrated/mentioned embodiments may be combined in additional embodiments. Consequently, the description and the drawings should be considered in an illustrative rather than restrictive sense.

It is also obvious that all the characteristics described with reference to one method are transposable, alone or in combination, to one device, and conversely, all the characteristics described with reference to one device are transposable, alone or in combination, to one method.

1. An assembly comprising a hydraulic machine and a steering yoke, the hydraulic machine comprising a rotor and a stator moveable in rotation relative to each other along an axis of rotation extending along an axial direction, the hydraulic machine comprising a casing, the casing defining a pivot axis distinct from the axis of rotation, the steering yoke being assembled on the casing, wherein said steering yoke is assembled on the casing via a plurality of assembly elements extending along the axial direction, parallel to the axis of rotation.

2. The assembly according to claim 1, wherein the steering yoke comprises a control portion defining a steering axis parallel to the pivot axis.

3. The assembly according to claim 1, wherein said assembly elements comprise a plurality of elements adapted to be screwed into the casing, the assembly comprising at least one centering element each having a first end inserted into a housing formed in the casing, and a second end inserted into a housing formed in the steering yoke.

4. The assembly according to claim 3, wherein the centering elements are mounted stressed in the casing and in the steering yoke.

5. The assembly according to claim 4, wherein the centering elements have an outer section strictly greater than a section of the housing formed in the casing and strictly greater than a section of the housing formed in the steering yoke.

6. The assembly according to claim 3, comprising two centering elements each having a first end inserted into a housing formed in the casing, and a second end inserted into a housing formed in the steering yoke.

7. The assembly according to claim 3, wherein the hydraulic machine comprises a cam secured to the casing, the cam being secured to the casing by means of a plurality of fixing elements extending along the axial direction, the steering yoke comprising at least one bore along the axial direction aligned with at least one of said fixing elements, said bore having a section smaller than the maximum section of said fixing elements wherein the centering elements are positioned in the extension of the fixing elements.

8. The assembly according to claim 7, wherein said centering elements have an annular shape with a central recess, each of said at least one bore of the steering yoke being aligned with the central recess of a centering element.

9. The assembly according to claim 8, wherein each of said at least one bore of the steering yoke has a section strictly smaller than the section of the centering elements.

10. The assembly according to claim 1, wherein the casing has two assembly areas adapted to receive a steering yoke, the steering yoke comprising a mistake-proofing adapted to allow the assembly of the steering yoke on a single assembly area of the casing.

11. A method for assembling an assembly according to claim 1, wherein the steering yoke is positioned on the casing, and the steering yoke is assembled on the casing via a plurality of assembly elements extending along the axial direction of the hydraulic machine.

12. The assembly method according to claim 11, wherein prior to positioning the steering yoke on the casing, centering elements are inserted under stress into housings formed in one among the steering yoke and the casing, then the steering yoke is positioned on the casing by inserting under stress the centering elements into housings formed in the other among the steering yoke and the casing.
